(19) United States
(12) Patent Application Publication
(10) Pub. No.: US 2024/0374353 A1
(43) Pub. Date: Nov. 14, 2024

(54) ORTHODONTIC DEVICES

(71) Applicant: Braces On Demand Inc., Hicksville, NY (US)

(72) Inventors: Colin James Corey, Carlsbad, CA (US); Edward L. Massaro, Bryn Mawr, PA (US); Ronald M. Malerstein, Huntington Beach, CA (US); James E. Paschal, JR., Madison, GA (US)

(21) Appl. No.: 18/650,390

(22) Filed: Apr. 30, 2024

Related U.S. Application Data
(60) Provisional application No. 63/501,336, filed on May 10, 2023.

(51) Int. Cl. A61C 7/16; A61C 7/14; A61C 7/28

(52) U.S. Cl. CPC A61C 7/16; A61C 7/14; A61C 7/285

(57) ABSTRACT

In some embodiments, an orthodontic appliance comprises a main body portion, the main body portion including a first end and a second end, wherein the first end is opposite the second end, and wherein the first end includes a first eyelet and the second end include a second eyelet, a first orthodontic device, wherein the first orthodontic device is configured to be bonded to a first tooth in a patient's mouth, wherein the first orthodontic device includes a first protrusion, and wherein the first protrusion is located within the first eyelet during use in the patient's mouth, and a second orthodontic device, wherein the second orthodontic device is configured to be bonded to a second tooth in the patient's mouth, wherein the second orthodontic device includes a second protrusion, and wherein the second protrusion is located within the second eyelet during use in the patient's mouth.

This invention relates generally to orthodontics and, more specifically, orthodontic appliances.

### BACKGROUND

Orthodontic clinicians seek to correct malocclusions by use of many different devices, such as braces, aligners, expanders, etc. Braces, otherwise known as brackets, are one of the most commonly used devices. Adjuncts to brackets include archwires, ligatures, and elastics. Brackets are affixed to a patient's teeth and the archwire passes through slots in the brackets designed to receive the archwire. The ligatures secure the archwire within the slots. Elastics attach brackets in the same dental arch or in opposing dental arches in order to provide additional orthodontic movement possibilities. In the treatment of some malocclusions, orthodontic clinicians may use Class II Correctors and/or Class III Correctors. Class II Correctors and Class III Correctors are typically bonded to two teeth in a patient's mouth and include a bar that spans the distance between the two teeth. Often, Class II Correctors and Class III Correctors feature a multipiece design, where the individual components are connected via a ball-and-socket mechanism. While a ball-and-socket mechanism is capable of providing Class II/III correction, this design has drawbacks. For example, such Class II Correctors and Class III Correctors are typically manufactured as discrete components to be assembled by the manufacturer or the orthodontic clinician. Such manufacturing techniques make the manufacture of such Class II Correctors and Class III Correctors more difficult, and expensive. Additionally, the required assembly of such Class II Correctors and Class III Correctors poses challenges for the manufacturer and/or orthodontic clinician. Accordingly, an improved design for Class II Correctors and Class III Correctors is desired.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a top view of an orthodontic appliance 100, according to some embodiments.

FIG. 1B is a front view of an orthodontic appliance 100, according to some embodiments.

FIG. 1C is a rear view of an orthodontic appliance 100, according to some embodiments.

FIG. 1D is a perspective view of an orthodontic appliance 100, according to some embodiments.

FIG. 2A is a top view of a carrier 214 housing orthodontic appliances, according to some embodiments.

FIG. 2B is a perspective view of a carrier 214 housing orthodontic appliances, according to some embodiments.

FIG. 3A is a first side view of a protrusion 322, according to some embodiments.

FIG. 3B is a second view of a protrusion 322, according to some embodiments.

FIG. 3C is a perspective view of a protrusion 322, according to some embodiments.

FIG. 3D is a top view of a protrusion 322, according to some embodiments.

FIG. 3E is a bottom view of a protrusion 322, according to some embodiments.

FIG. 4A depicts a main body portion 402 and a protrusion of a first orthodontic device 404 seated within a first eyelet 406, according to some embodiments.

FIG. 4B is a sectional view of a main body portion 402 and a protrusion of a first orthodontic device 404 seated within a first eyelet 406, according to some embodiments.

FIG. 5A depicts a main body portion 502 and a protrusion of a first orthodontic device 504 seated within a first eyelet 506 after the first orthodontic device 504 has been rotated clockwise with respect to the first eyelet 506, according to some embodiments.

FIG. 5B is a sectional a main body portion 502 and a protrusion of a first orthodontic device 504 seated within a first eyelet 506 after the first orthodontic device 504 has been rotated clockwise with respect to the first eyelet 506, according to some embodiments.

FIG. 6A depicts a main body portion 602 and a protrusion of a first orthodontic device 604 seated within a first eyelet 606 after the first orthodontic device 604 has been rotated counterclockwise with respect to the first eyelet 606, according to some embodiments.

FIG. 6B is a sectional view a main body portion 602 and a protrusion of a first orthodontic device 604 seated within a first eyelet 606 after the first orthodontic device 604 has been rotated counterclockwise with respect to the first eyelet 606, according to some embodiments.

FIG. 7A depicts an orthodontic appliance 700 having a first eyelet 706 having an opening 714, according to some embodiments.

FIG. 7B depicts an orthodontic appliance 700 having a first eyelet 706 having an opening 714, according to some embodiments.

FIG. 7C depicts an orthodontic appliance 700 having a first eyelet 706 having an opening 714, according to some embodiments.

FIG. 8 is a block diagram of a system 800 for manufacturing orthodontic appliances, according to some embodiments.

FIG. 9 is a flow chart depicting example operations for manufacturing orthodontic appliances, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to orthodontic appliances. In some embodiments, an orthodontic appliance comprises a main body portion, the main body portion including a first end and a second end, wherein the first end is opposite the second end, and wherein the first end includes a first eyelet and the second end includes a second eyelet, a first orthodontic device, wherein the first orthodontic device is configured to be bonded to a first tooth in a patient's mouth, wherein the first orthodontic device includes a first protrusion, and wherein the first protrusion is located within the first eyelet during use in the patient's mouth, and a second orthodontic device, wherein the second orthodontic device is configured to be bonded to a second tooth in the patient's mouth, wherein the second orthodontic device includes a second protrusion, and wherein the second protrusion is located within the second eyelet during use in the patient's mouth.

As previously discussed, typical Class II Correctors and Class III Correctors feature a multipiece design. Accordingly, the components of the Class II Corrector and Class III Corrector are manufactured separately and require assembly, whether by the manufacturer or a clinician. Because the components are manufactured separately, the complexity and cost of manufacture is increased. Additionally, assembly of the components to form the Class II Corrector and Class III Corrector can be difficult and/or cause frustration. Further, such Class II and Class III Correctors are subject to forces applied to the orthodontic appliance that can cause the orthodontic appliance to break or de-bond from the tooth. For example, a force exerted on a main body portion of the orthodontic appliance can cause the orthodontic appliance to break (e.g., at one of the orthodontic devices, in the main body portion, etc.) or one (or both) of the orthodontic devices to be de-bonded from the tooth. This can occur because traditional designs allow for only minimal movement between the main body portion and the orthodontic devices. Described herein are orthodontic appliances, as well as systems, methods, and apparatuses associated with orthodontic appliances, that seek to minimize, if not eliminate, the problems of traditional Class II Correctors and Class III Correctors. For the case of readability, the following discussion will refer simply to Class II Correctors, though it should be noted that the teachings described herein can apply to both Class II Correctors and Class III Correctors.

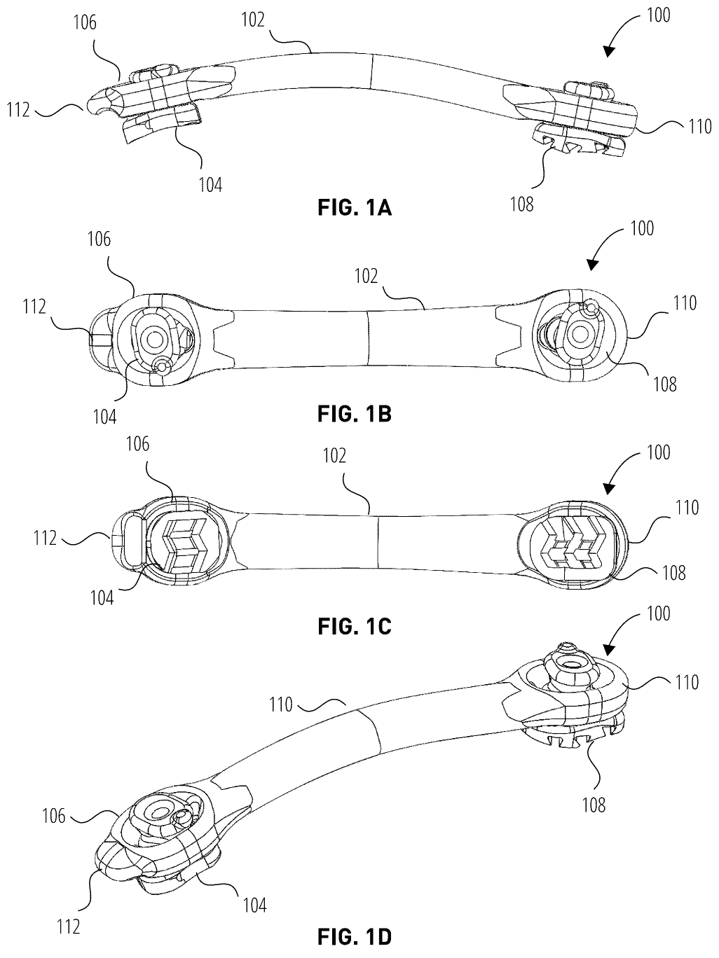

In one embodiment, an orthodontic appliance (e.g., a Class II Corrector or Class III Corrector) includes a main body portion, a first orthodontic device, and a second orthodontic device. The main body portion includes a first eyelet and a second eyelet. In use, the first orthodontic device seats within the first eyelet and the second orthodontic device seats within the second eyelet. The orthodontic devices include protrusions that seat within the eyelets. Because the orthodontic devices seat within the eyelets, the orthodontic devices are not rigidly secured/affixed to the main body portion. Accordingly, such a configuration allows for movement of the main body portion relative to the first and/or second orthodontic device. Such movement can, in some embodiments, provide for flexing of the orthodontic appliance which can prevent breakage of the orthodontic appliances and/or de-bonding of the first and/or second orthodontic device. The discussion of FIG. 1 provides an overview of such orthodontic appliances.

FIGS. 1A-1D depict various views of an orthodontic appliance 100, according to some embodiments. The orthodontic appliance 100 includes a main body portion 102, a first orthodontic device 104, and a second orthodontic device 108. In one embodiment, as depicted in FIGS. 1A-1D, the main body portion 102 is an elongated member. The main body portion 102 includes a first end and a second end opposite the first end. A first eyelet 106 is located at the first end and a second eyelet 110 is located at the second end. The main body portion 102 is securable to the first orthodontic device 104 and the second orthodontic device 108 to form the orthodontic appliance 100. In one embodiment, as depicted in FIGS. 1A-1D, the first orthodontic device 104 and the second orthodontic device 108 include protrusions. The protrusions seat within the eyelets in use. That is, when in use, the first orthodontic device 104 seats within the first eyelet 106 and the second orthodontic device 108 seats within the second eyelet 110.

The first orthodontic device 104 and the second orthodontic device 108 are configured to be bonded to teeth in the patient's mouth. The first orthodontic device 104 is configured to be bonded to a first tooth in the patient's mouth. The first tooth can be any suitable tooth based, for example, on the patient's facial geometry, a prescription for the patient, the desired movement of the patient's teeth, etc. The second orthodontic device 108 is configured to be bonded to a second tooth in the patient's mouth. The second tooth can be any suitable tooth based, for example, on the patient's facial geometry, a prescription for the patient, the desired movement of the patient's teeth, etc. Though referred to as a “first tooth” and a “second tooth,” it should be noted that the terms “first” and “second” do not indicate specific teeth within the patient's mouth with which the first orthodontic device 104 and second orthodontic device 108 are configured to be bonded. Rather, the use of the terms “first” and “second” simply denotes that, in use in a patient's mouth, the first orthodontic device 104 is bonded to a different tooth than the second orthodontic device 108. The first orthodontic device 104 and the second orthodontic device 108 can be bonded to the patient's teeth in any suitable manner. For example, the first orthodontic device 104 and the second orthodontic device 108 can be bonded to the patient's teeth via a bonding material, such as an adhesive, cement, etc.

Additionally, as depicted in FIGS. 1A-1D, in some embodiments, the orthodontic appliance 100 includes a hook 112. The hook 11212 can be used to secure a ligature (e.g., a ligature that extends from the orthodontic appliance 100 to another orthodontic appliance). Though the hook 112 is depicted in FIG. 1 as extending from an end of the main body portion 102 (i.e., on the outside of the first orthodontic device 104), embodiments are not so limited. For example, in some embodiments, the hook 112 can be located on the main body portion 102 inside of the first user first orthodontic device 104 (i.e., between the first orthodontic device 104 and the second orthodontic device 108) or on the first orthodontic device 104.

The orthodontic appliance 100 can be manufactured from any suitable material(s). For example, the orthodontic appliance 100 can be manufactured from plastic, composite, metal, etc. Additionally, in some embodiments, the orthodontic appliance 100 can be manufactured from multiple materials. For example, the first orthodontic device 104 and the second orthodontic device 108 can be manufactured from metal, and other portions of the main body portion 102 can be manufactured from plastic. Accordingly, the orthodontic appliance 100 can be manufactured using any suitable manufacturing techniques, or combination of manufacturing techniques. For example, the orthodontic appliance 100 can be molded, cast, sculpted, additively manufactured, etc. In one embodiment, the main body portion 102 is manufactured separately from the first orthodontic device 104 and the second orthodontic device 108. In such embodiments, the orthodontic appliance 100 is assembled by inserting the first orthodontic device 104 into the first eyelet 106 and the second orthodontic device 108 into the second eyelet 110.

In another embodiment, the orthodontic appliance 100 is manufactured as a single structure. That is, the orthodontic appliance, as manufactured, includes both the main body portion 102, the first orthodontic device 104, and the second orthodontic device 108. In such embodiments, because the orthodontic appliance 100 is manufactured as a single structure, the orthodontic appliance 100 does not require assembly (i.e., the main body portion 102, the first orthodontic device 106, and the second orthodontic device 108 are manufactured in an assembled state). In one embodiment, as described in more detail herein, the orthodontic appliance 100 is additively manufactured as a single structure. Additional detail regarding the additive manufacture of orthodontic appliances and systems can be found in U.S. patent application Ser. No. 16/875,618 filed May 15, 2020 and titled SYSTEMS AND METHODS FOR MANUFACTURE OF ORTHODONTIC APPLIANCES and U.S. patent application Ser. No. 17/011,121 filed Sep. 3, 2020 and titled SYSTEMS AND METHODS FOR MANUFACTURING ORTHODONTIC DEVICES, both of which are herein incorporated by reference in their entirety. With respect to U.S. patent application Ser. No. 17/011,121, the orthodontic kits can be analogized to the orthodontic appliance 100 and packaging described herein. Additionally, the orthodontic appliance 100 can be similar to the orthodontic appliance described in U.S. patent application Ser. No. 17/233,116 filed Apr. 16, 2021 and titled ORTHODONTIC DEVICES, which is herein incorporated by reference in its entirety.

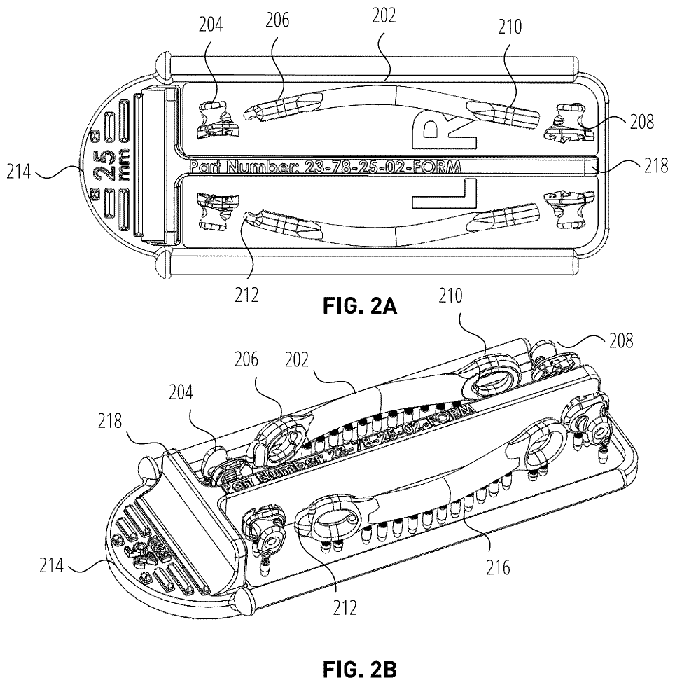

While the discussion of FIGS. 1A-1D provides an overview of the orthodontic appliances described herein, the discussion of FIGS. 2-7 provides additional detail regarding such orthodontic appliances.

FIGS. 2A and 2B depict a carrier 214 housing orthodontic appliances, according to some embodiments. In some embodiments, the carrier 214 can be referred to as “packaging” for the orthodontic appliances. The carrier 214 can comprise a complex geometry (e.g., as show in FIGS. 2A and 2B), or be a more simple structure, such as the packaging described in U.S. patent application Ser. No. 17/233,116, discussed above and incorporated by reference in its entirety herein.

As depicted in FIGS. 2A and 2B, the orthodontic appliances include a main body portion 202, a first orthodontic device 204, and a second orthodontic device 208. The main body portion 202 includes a first eyelet 206 and a second eyelet 210. In use, the first orthodontic device 204 seats within the first eyelet 206 and the second orthodontic device 208 seats within the second eyelet 210. Though depicted in FIGS. 2A and 2B as being manufactured in an unassembled state, embodiments are not so limited. For example, in some embodiments, the orthodontic appliance can be manufactured in an assembled state such that the first orthodontic device 204 is seated within the first eyelet 206 and the second orthodontic device 208 is seated within the second eyelet 210. In such embodiments, the orthodontic appliance can be housed in, on, and/or within the carrier 214 in an assembled state.

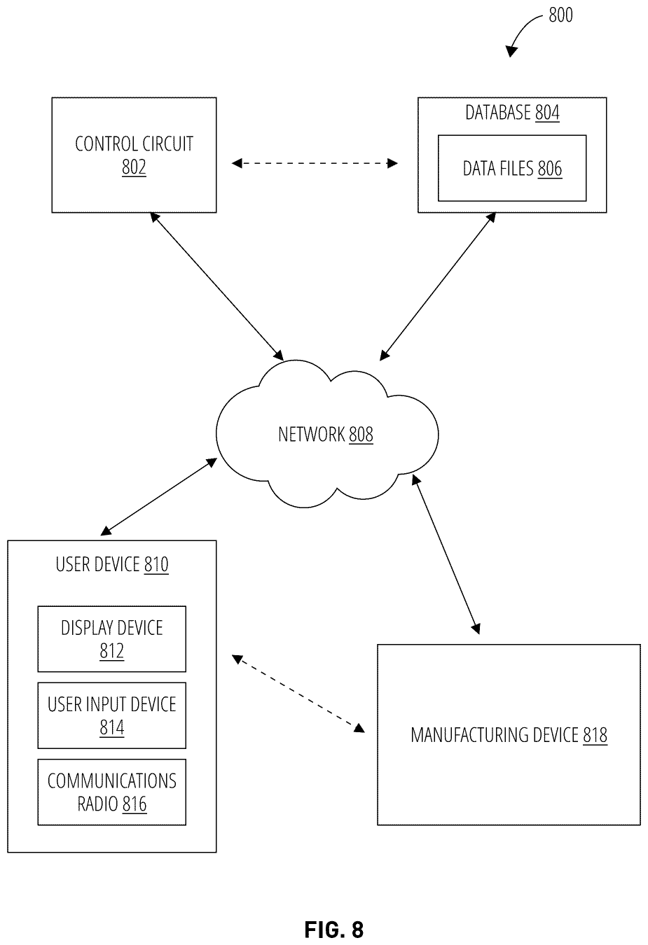

In one embodiment, the orthodontic appliances are secured to the carrier 214 via support structures 216. For example, if the orthodontic appliance and the carrier 214 are additively manufactured as a single structure, the carrier 214, support structures 216, and the components of the orthodontic appliances are manufactured as a single structure. In such embodiments, the carrier 214, support structures 216, and components of the orthodontic appliances can be additively manufactured based on a computer data file, as described in more detail with respect to FIG. 8. In some embodiments, the support structures 216 can be designed and/or formed to facilitate easy removal of the orthodontic appliances from the carrier 214. For example, the support structures 216 can be thinner, or otherwise include less material, at a joint between each of the support structures 216 and the orthodontic appliances. For example, the support structures 216 can feature a tapered (e.g., single taper or double taper) design. Further detail regarding the geometry and configuration of the support structures 216 can be found in U.S. patent application Ser. No. 16/875,618, discussed above and incorporated by reference in its entirety herein.

The carrier 214 acts to house the orthodontic appliances. In one embodiment, the carrier 214 acts as base upon which the orthodontic appliances can be additively manufactured. In some embodiments, the carrier 214 can include features to protect, or help prevent accidental damage from occurring to, the orthodontic appliances. For example, as depicted in FIGS. 2A and 2B, the carrier 214 can include one or more raised rails 218. The raised rails 218 can, for example, extend from the carrier 214 above a height of the orthodontic appliances. Such raised rails 218 can prevent the orthodontic appliances from contacting a structure, such as a tabletop or the ground, if the carrier 214 is accidentally dropped. Further detail regarding similar carriers 214 can be found in U.S. patent application Ser. No. 17/011,121, discussed above and incorporated by reference in its entirety herein.

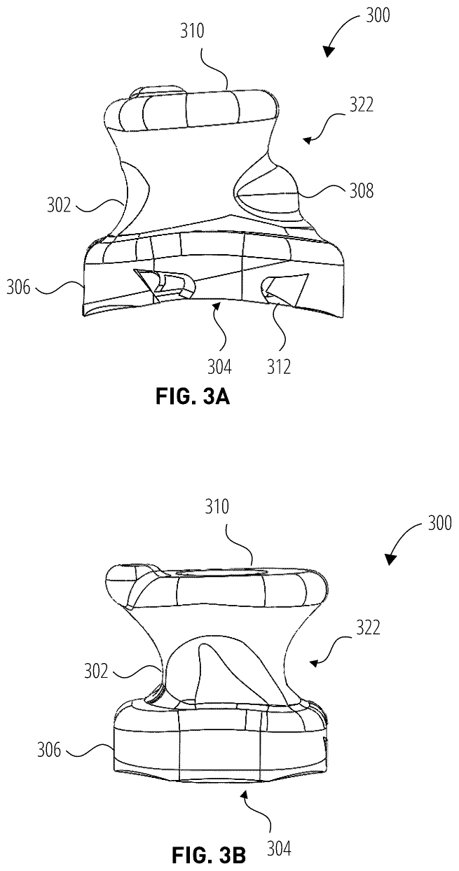

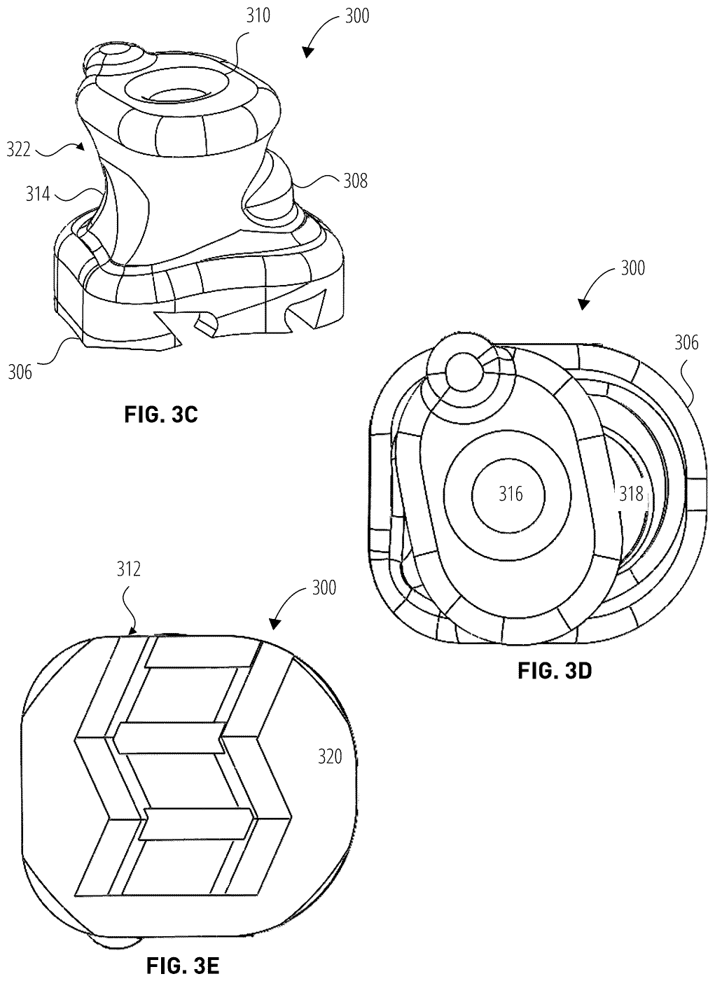

While the discussion of FIGS. 2A and 2B provides additional detail regarding a carrier housing orthodontic appliances, the discussion of FIG. 3 provides additional detail regarding orthodontic devices of an orthodontic appliance.

FIGS. 3A-3E depict various views of an orthodontic device 300, according to some embodiments. The orthodontic device 300 can be a first orthodontic device or a second orthodontic device (as the terms are used in herein) and generally includes a base 306, a protrusion 322, and an upper portion 310. The base 306 includes a bonding surface 304. The protrusion 322 extends from the base 306. The upper portion 310 is located at a top of the protrusion 322, and a central portion 302 of the protrusion 322 is located between the base 306 and the upper portion 310.

The protrusion 322 can take any suitable form. For example, the protrusion 322 can be cylindrical, rectangular, spherical, etc. Further, the protrusion 322 can take more complex shapes. For example, as depicted in FIGS. 3A-3E, the central portion 302 of the protrusion is generally smaller (e.g., has a narrower width, smaller diameter, etc.) than one or both of the base 306 and the upper portion 310. In such embodiments, the wider base 306 and/or wider upper portion 310 can act as a limit. The limit can control movement of the main body portion with respect to the orthodontic device 300 via physical engagement between the eyelet and the limit. For example, for a Class II Corrector, it may be advantageous to limit rotation in a tip plane while allowing more freedom of rotation about the root axis. As another example, for a Class III Corrector, it may be advantageous to limit rotation about the root axis and allow tip rotation only in a positive direction. The geometries of the protrusion 322 and/or the eyelet can be tailored to achieve these, as well as any other, movement restriction goals. Additionally, the limit can prevent disassembly of the orthodontic appliance (i.e., removal of the eyelet from the protrusion 322). Additionally, the degree to which the main body portion can move with respect to the orthodontic device 300 can be controlled by varying the size and/or geometry of the protrusion 332. For example, if more freedom of movement is desired, the diameter of the protrusion 322 between the base 306 and the upper portion 310 can be decreased, or the diameter of the eyelet can be increased.

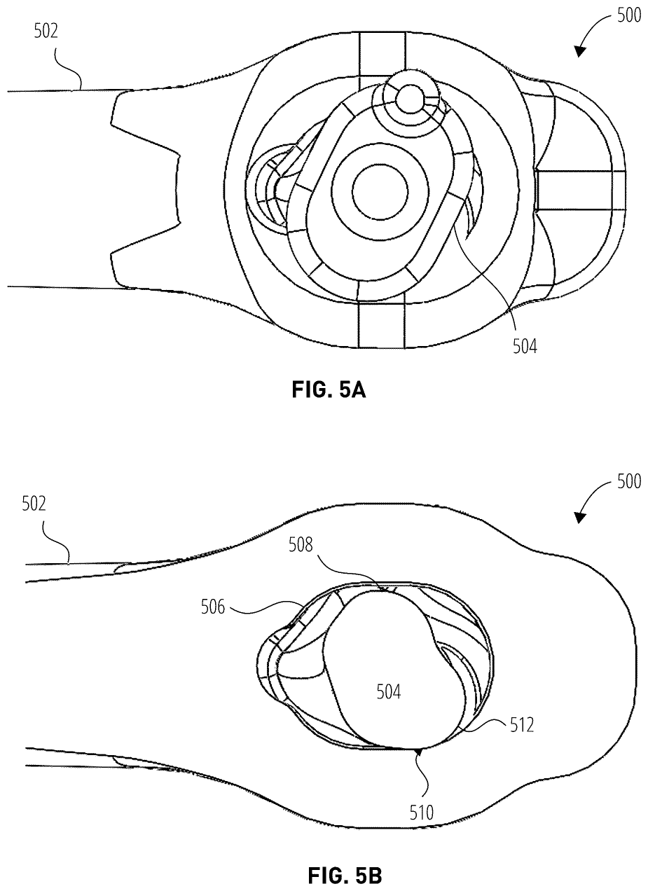

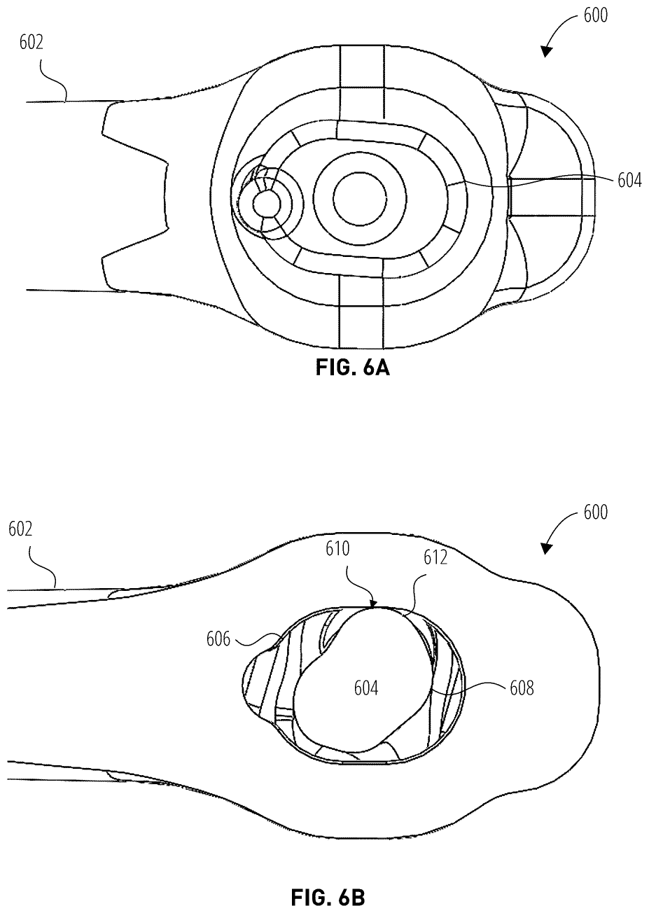

Further, as well-depicted in FIG. 3A, the protrusion 322 can include an asymmetric feature 308. The asymmetric feature 308 can be sized and/or positioned on the protrusion 322 to limit rotation of the orthodontic device 300 with respect to an eyelet in which the orthodontic device 300 seats, as described in more detail with respect to FIGS. 5-6. Generally, the asymmetric feature 308 extends from the protrusion 322 irregularly (i.e., asymmetrically). Due to the asymmetric nature of the asymmetric feature 308, the asymmetric feature 308 will contact a border of an eyelet at varying degrees of rotation based on the direction of rotation of the main body portion with respect to the orthodontic device 300. Accordingly, the asymmetric feature 308 can act as a rotation-limiting feature.

The base 306 is configured to be bonded to a tooth in a patient's mouth. As can be seen in FIG. 3E, the base 306 of the orthodontic device 300 includes retentive grooves 312. The retentive grooves 312 can allow bonding material (e.g., an adhesive) to flow into the retentive groove 312 to aid in bonding the orthodontic device 300 to the patient's tooth. Further, in some embodiments and as depicted in FIG. 3E, the retentive grooves 312 can be nonlinear. Examples of such retentive grooves 312 are described in more detail in U.S. patent application Ser. No. 17/743,596 filed May 13, 2022 and titled ORTHODONTIC APPLIANCES, which is herein incorporated by reference in its entirety. As one example, the retentive grooves 312 can include dovetails to aid in bonding the orthodontic device 300 to a tooth in the patient's mouth. Further, in some embodiments, the bonding surface 320 can be curved (e.g., to match, or approximate, the curvature of a surface of the patient's tooth). In such embodiments, the retentive grooves 312 can follow the curvature of the bonding surface 320, though such is not required.

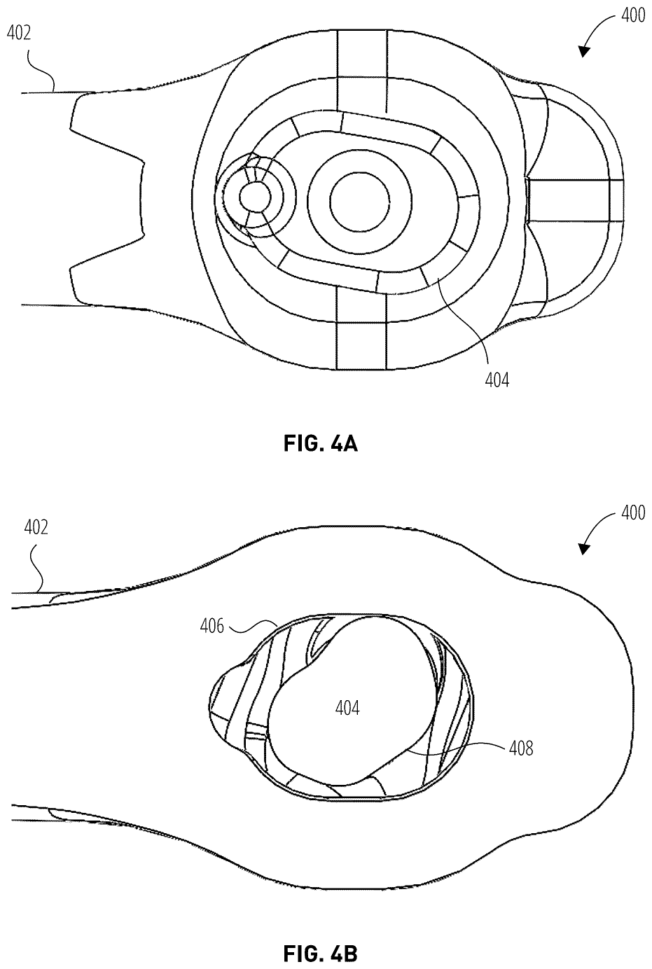

While the discussion of FIGS. 3A-3E provide additional detail regarding orthodontic devices, the discussion of FIGS. 4-6 provides additional detail regarding seating an orthodontic appliance in an eyelet.

FIGS. 4A and 4B depict a first orthodontic device 404 seated within a first eyelet 406 of an orthodontic appliance 400, according to some embodiments. FIGS. 4A and 4B depict the first orthodontic device 404 seated within the first eyelet 406 in a neutral orientation. For example, the first orthodontic device 404 is seated within the first eyelet 406 in a neutral orientation in that the first orthodontic device 404 is bonded to a first tooth in the patient's mouth an no abnormal (e.g., external) forces are acting upon the orthodontic appliance 400 (i.e., the orthodontic appliance 400 is in a resting state without external forces, such as from chewing, pressing, etc., being exerted on the orthodontic appliance 400).

As depicted in FIGS. 4A and 4B, a central portion 408 of the first orthodontic device 404 is interacting with the first eyelet 406. Because the orthodontic appliances 400 is in a neutral orientation, there is minimal, if any, contact between the central portion 408 and the inner walls of the first eyelet 406.

While the orthodontic appliance 400 depicted in FIGS. 4A and 4B is in a neutral orientation, the orthodontic device depicted in FIGS. 5A and 5B is rotated clockwise with respect to the main body portion of the orthodontic appliance.

FIGS. 5A and 5B depict a first orthodontic device 504 seated within a first eyelet 506 of an orthodontic appliance 500 after the first orthodontic device 504 has been rotated clockwise with respect to the first eyelet 506, according to some embodiments. Because the main body portion 502 of the orthodontic appliance 500 includes the first eyelet 506, the first orthodontic device 504 is also rotated clockwise with respect to the main body portion 502. The first orthodontic device 504 includes a protrusion including a central portion 508, as described with respect to FIGS. 3A-3E. The central portion 508 includes an asymmetric feature 512 which, in this example, can act as a rotation-limiting feature. The asymmetric feature 512 extends from the central portion 508 of the protrusion. When the first orthodontic device 504 is rotated with respect to the first eyelet 506, the first orthodontic device 504 rotates until the it contacts an inner wall of the first eyelet 506. Because the asymmetric feature 512 is an irregularly shaped extension of the protrusion (i.e., the central portion 508 of the protrusion is not symmetric due to the asymmetric feature 512), the first orthodontic device 504 can rotate within the first eyelet 506 until the asymmetric feature 512 contacts an inner wall of the first eyelet 506.

As can be seen in the sectional view depicted in FIG. 5B, the asymmetric feature 512 contacts the inner wall of the first eyelet 506 at an interference point 510. The contact between the asymmetric feature 512 and the inner wall of the first eyelet 506 at the interference point 510 acts as limit on the rotation of the first orthodontic device 504 with respect to the first eyelet 506 and/or the main body portion 502 of the orthodontic appliance 500. Because of the geometry of the central portion 508 of the first orthodontic device 504 and the asymmetric feature 512, the first orthodontic device 504 can rotate approximately 90° to 180° in a clockwise direction relative to the first eyelet 506 before the asymmetric feature 512 contacts the inner wall of the first eyelet 506. It should be noted that the range of 90° to 180° is provided as an example, and any desired rotational limits are possible. That is, the geometry, shape, size, etc. of first orthodontic device 504, the central portion 508, the asymmetric feature 512, and/or the first eyelet 506 can be tailored to achieve the desired rotational limits. Further, while the discussion of FIGS. 4-6 refer to the first orthodontic device 504 and the first eyelet 506, it should be noted that similar features and/or functionality can apply to the second orthodontic device and/or second eyelet. For example, like the first orthodontic device 504, the second orthodontic device can include an asymmetric feature.

The rotational limits provided by the orthodontic appliance 500 can provide a number of advantages. As a first example, allowing the first orthodontic device 504 to rotate with respect to the first eyelet 506 allows the orthodontic appliance 500 to absorb forces without breaking and/or causing the first orthodontic device 504 to be de-bonded from the patient's tooth. For example, if the patient is eating a portion of the food in the patient's mouth is forced into the orthodontic appliance 500 by the patient chewing, the rotation afforded to the first orthodontic device 504 and/or the main body portion 502 allows a level of deformation of the orthodontic appliance 500 to absorb and/or compensate for at least a portion of this force. As another example, allowing the first orthodontic device 504 to rotate with respect tot he first eyelet 506 allows clinically-designed forces to be applied to the orthodontic appliance 500 in a desired manner (e.g., with a ligature between the orthodontic appliance 500 and another orthodontic appliance(s)).

While the discussion of FIGS. 5A and 5B provides additional detail regarding rotation of a first orthodontic device in a clockwise direction with respect to a first eyelet, the discussion of FIGS. 6A and 6B provides additional detail regarding rotation of a first orthodontic device in a counterclockwise direction with respect to a first eyelet.

FIGS. 6A and 6B depict a first orthodontic device 604 seated within a first eyelet 606 of an orthodontic appliance 600 after the first orthodontic device 604 has been rotated counterclockwise with respect to the first eyelet 606, according to some embodiments. Because the main body portion 602 of the orthodontic appliance 600 includes the first eyelet 606, the first orthodontic device 604 is also rotated counterclockwise with respect to the main body portion 602. The first orthodontic device 604 includes a protrusion including a central portion 608, as described with respect to FIGS. 3A-3E. The central portion 608 includes an asymmetric feature 612. The asymmetric feature 612 extends from the central portion 608 of the protrusion. When the first orthodontic device 604 is rotated with respect to the first eyelet 606, the first orthodontic device 604 rotates until the it contacts an inner wall of the first eyelet 606. Because the asymmetric feature 612 is an irregularly shaped extension of the protrusion (i.e., the central portion 608 of the protrusion is not symmetric due to the asymmetric feature 612), the first orthodontic device 604 can rotate within the first eyelet 606 until the asymmetric feature 612 contacts an inner wall of the first eyelet 606.

As can be seen in the sectional view depicted in FIG. 6B, the asymmetric feature 612 contacts the inner wall of the first eyelet 606 at an interference point 610. The contact between the asymmetric feature 612 and the inner wall of the first eyelet 606 at the interference point 610 acts as limit on the rotation of the first orthodontic device 604 with respect to the first eyelet 606 and/or the main body portion 602 of the orthodontic appliance 600. Because of the geometry of the central portion 608 of the first orthodontic device 604 and the asymmetric feature 612, the first orthodontic device 604 can rotate approximately 15° to 45° in a counterclockwise direction relative to the first eyelet 606 before the asymmetric feature 612 contacts the inner wall of the first eyelet 606. It should be noted that the range of 15° to 45° is provided as an example, and any desired rotational limits are possible. That is, the geometry, shape, size, etc. of first orthodontic device 604, the central portion 608, the asymmetric feature 612, and/or the first eyelet 606 can be tailored to achieve the desired rotational limits. Further, while the discussion of FIGS. 4-6 refer to the first orthodontic device 604 and the first eyelet 606, it should be noted that similar features and/or functionality can apply to the second orthodontic device and/or second eyelet. For example, like the first orthodontic device 604, the second orthodontic device can include an asymmetric feature. Further, because the asymmetric feature 612 is asymmetric, the rotational limit for counterclockwise rotation can be different than the rotational limit for clockwise rotation. It should be noted that although in the example provided in FIGS. 5 and 6 the rotational limit is greater in the clockwise direction that the counterclockwise direction, embodiments are not so limited. For example, the rotational limits can be reversed when the orthodontic appliance 500 is used on an opposite side of the patient's mouth. Further, in some embodiments, the clockwise rotational limits can be the same, or nearly the same, as the counterclockwise rotational limits, if desired.

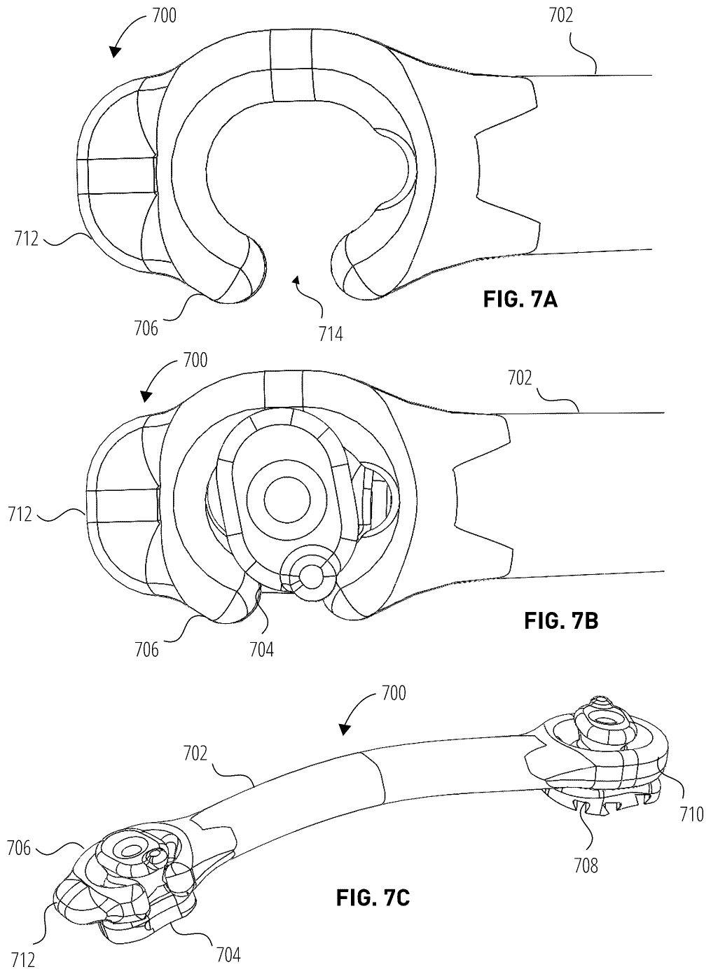

While the discussion of FIGS. 4-6 provide additional detail regarding seating an orthodontic device in an eyelet, the discussion of FIGS. 7A-7C provides additional detail regarding an alternative embodiment for an eyelet.

FIGS. 7A-7C depict an orthodontic appliance 700 having a first eyelet 706 that includes an opening 714, according to some embodiments. As depicted in FIGS. 7A-7C, the orthodontic appliance 700 includes a main body portion 702, a first orthodontic device 704, and a second orthodontic device 708. The main body portion 702 includes a first eyelet 706 and a second eyelet 710. The first eyelet 706 is located at a first end of the main body portion 702 and the second eyelet 710 is located at a second end of the main body portion 702 opposite the first end. While the second eyelet 710 is depicted as fully enclosing the second orthodontic device 708, the first eyelet 706 includes an opening 714. The opening 714 can provide additional rotational freedom and/or allow for case of assembly of the orthodontic appliance 500.

Additionally, as depicted in FIGS. 7A-7C, in some embodiments, the orthodontic appliance 700 includes a hook 712. The hook 712 can be used to secure a ligature (e.g., a ligature that extends from the orthodontic appliance 700 to another orthodontic appliance). Though the hook 712 is depicted in FIG. 7 as extending from an end of the main body portion 702 (i.e., on the outside of the first orthodontic device 704), embodiments are not so limited. For example, in some embodiments, the hook 712 can be located on the main body portion 702 inside of the first user first orthodontic device 704 (i.e., between the first orthodontic device 704 and the second orthodontic device 708) or on the first orthodontic device 704.

While the discussion of FIGS. 7A-7C provides additional detail regarding an alternative embodiment for an eyelet, the discussion of FIG. 8 provides additional detail regarding the manufacture of orthodontic appliances 600.

FIG. 8 is a block diagram of a system 800 for manufacturing orthodontic appliances, according to some embodiments. The system 800 includes a Control Circuit 802, a database 804, a user device 810, and a manufacturing device 818. One or more of the Control Circuit 802, the database 804, the user device 810, and the manufacturing device 818 are communicatively coupled via a network 808. The network 808 can include a local area network (LAN) and/or wide area network (WAN), such as the internet. Accordingly, the network 808 can include wired and/or wireless links.

The user device 810 can be any suitable type of computing device (e.g., a desktop or laptop computer, smartphone, tablet, etc.). The user device 810 includes a display device 812. The display device 812 is configured to present a catalogue to a user. The catalogue includes orthodontic appliances that the user can obtain via the system 800, such as the orthodontic appliances described herein (i.e., orthodontic appliances and/or packaged orthodontic appliances). For example, the catalogue can include all orthodontic devices that the user can purchase and/or manufacture via the manufacturing device 818. The user interacts with the catalogue via a user input device 814. The user can interact with the catalogue by navigating the catalogue, making selections from the catalogue, modifying orthodontic appliances included in the catalogue, etc. Accordingly, the user input device 814 can be of any suitable type, such as a mouse, keyboard, trackpad, touchscreen, etc. The user device 810 also includes a communications radio 816. The communications radio 816 transmits and receives information for the user device 810. For example, in the case of a smartphone, the communications radio 816 can be a cellular radio operating in accordance with the 4G LTE standard. Once a user has made a selection of an orthodontic appliance, the user device 810, via the communications radio 816 and the network 808, transmits an indication of the selection to the Control Circuit 802.

The Control Circuit 802 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The Control Circuit 802 is configured (for example, by using corresponding programming as will be well understood by those skilled in the art) to carry out one or more of the steps, actions, and/or functions described herein.

By one optional approach the Control Circuit 802 operably couples to a memory. The memory may be integral to the Control Circuit 802 or can be physically discrete (in whole or in part) from the Control Circuit 802 as desired. This memory can also be local with respect to the Control Circuit 802 (where, for example, both share a common circuit board, chassis, power supply, and/or housing) or can be partially or wholly remote with respect to the Control Circuit 802 (where, for example, the memory is physically located in another facility, metropolitan area, or even country as compared to the Control Circuit 802).

This memory can serve, for example, to non-transitorily store the computer instructions that, when executed by the Control Circuit 802, cause the Control Circuit 802 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 810 and/or the manufacturing device 818. For example, the user device 810 and the manufacturing device 818 may be located in a clinician's office (e.g., the user's office) whereas the Control Circuit 802, and possibly the database 804, are cloud-based. The Control Circuit 802 generally operates to retrieve data files 806 based on the user's selection of orthodontic appliances. The Control Circuit 802 retrieves the data files 806 from the database 804. The database 804 is configured to store the data files 806. The data files 806 are associated with orthodontic appliances and/or packaged orthodontic appliances (i.e., orthodontic appliances including packaging). The data files 806 are CAD files from which the orthodontic appliances and/or packaged orthodontic appliances can be manufactured. The database 804 stores a data file for each of the orthodontic appliances included in the catalogue and/or each of the orthodontic systems included in the catalogue. In one embodiment, the database 804 stores a data file for all possible permutations of each orthodontic appliance (e.g., every possible modification and/or combination or modifications for each orthodontic appliance). The Control Circuit 802 receives the indication of the orthodontic appliance and/or packaged orthodontic appliance and retrieves a data file based on the indication of the orthodontic appliance and/or packaged orthodontic appliance.

It should be noted that the indication of the orthodontic appliance may include more than one orthodontic appliance. For example, the indication of the orthodontic appliance can include multiple orthodontic appliances, such as full set of brackets or other orthodontic appliances for a patient or an orthodontic system including a carrier structure and an assembly structure. Accordingly, the data file can be a file including instructions and/or specifications for multiple orthodontic appliances as well as structures in addition to the orthodontic appliances. For example, the data file may include multiple data files and/or multiple specifications for a number of brackets.

After retrieving the data file, the Control Circuit 802 transmits the data file. In some embodiments, the Control Circuit 802 encrypts or otherwise protects the data file before transmission. The Control Circuit 802 can encrypt or otherwise protect the data file before transmission to prevent those other than the user from accessing the data file. Additionally, in some embodiments, the Control Circuit 802 can encrypt or otherwise protect the data file to control the user's access to the data file. For example, in some embodiments, the system is set up such that users pay on a per manufacture or per print basis. That is, the user does not purchase, and may not later have access to, the data file. Rather, the user purchases access to print or otherwise manufacture an orthodontic appliance based on the data file once (or other specified number of times).

Dependent upon the embodiment, the Control Circuit 802 transmits the data file to the user device 810, the manufacturing device 818, or a third-party device (e.g., a laboratory capable of manufacturing the orthodontic appliance for the user). To whom, or to what device, the data file is transmitted may also aid in achieving access control. For example, in one embodiment, the Control Circuit 802 transmits the data file directly to the manufacturing device 818. Because the data file is not transmitted to the user device 810, the data file may not be easily accessible by the user device 810. Further, if an entity that controls the Control Circuit 802 controls the manufacturing device 818, access may to files received by the manufacturing device 818 may be further limited. In some embodiments, the Control Circuit 802 transmits the data files to the user device 810. In such embodiments, the user device 810 transmits, via the communications radio (e.g., over a universal serial bus (USB) connection, wireless connection based on the 802.11 standard, etc.), the data files to the manufacturing device 818.

The manufacturing device 818 additively manufacturers the orthodontic appliance(s) and/or orthodontic system based on the data file. The manufacturing device 818 can be of any suitable type, such as a 3D printer. The manufacturing device 818 can be local to, or remote from, one or more of the Control Circuit 802 and the user device 810. For example, in one embodiment, the user device 810 and the manufacturing device 818 are located in the user's office (i.e., the user device 810 and the manufacturing device 818 are local to one another). Alternatively, the manufacturing device 818 may be located in a laboratory or some other facility that manufactures orthodontic appliances for the user.

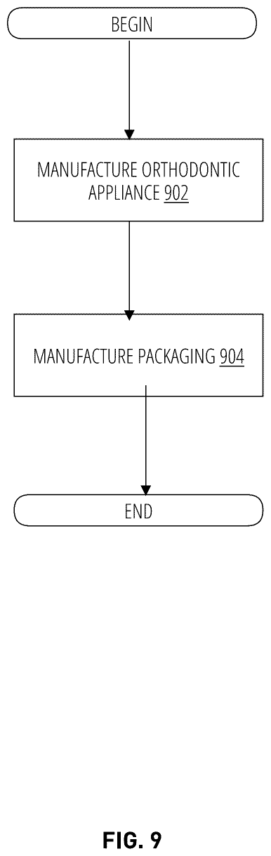

While the discussion of FIG. 8 provides additional detail regarding the manufacture of orthodontic systems, the discussion of FIG. 9 describes example operations for manufacturing packaged orthodontic appliances.

FIG. 9 is a flow chart depicting example operations for manufacturing orthodontic appliances, according to some embodiments. The flow begins at block 902.

At block 902, an orthodontic appliance is manufactured. For example, the orthodontic appliance can be additively manufactured. The orthodontic appliance comprises a main body portion and a second orthodontic device. The main body portion comprises a first orthodontic device configured to be bonded to a patient's tooth that is located proximal to a first end of the main body portion and an eyelet that is located proximal to a second end of the main body portion. The second orthodontic device is configured to be bonded to a patient's tooth and includes a protrusion. During manufacture (i.e., during at least some periods during the manufacturing process of the orthodontic appliance), the protrusion is located within the eyelet. The flow continues at block 904.

At block 904, packaging is manufactured. For example, the packaging can be additively manufactured. The packaging includes a plurality of support structures and a base. The plurality of support structures supports the orthodontic appliance and secures the orthodontic appliance to the base.

In some embodiments, an orthodontic appliance comprises a main body portion, the main body portion including a first end and a second end, wherein the first end is opposite the second end, and wherein the first end includes a first eyelet and the second end include a second eyelet, a first orthodontic device, wherein the first orthodontic device is configured to be bonded to a first tooth in a patient's mouth, wherein the first orthodontic device includes a first protrusion, and wherein the first protrusion is located within the first eyelet during use in the patient's mouth, and a second orthodontic device, wherein the second orthodontic device is configured to be bonded to a second tooth in the patient's mouth, wherein the second orthodontic device includes a second protrusion, and wherein the second protrusion is located within the second eyelet during use in the patient's mouth.

1. An orthodontic appliance, the orthodontic appliance comprising:
a main body portion, the main body portion including a first end and a second end, wherein the first end is opposite the second end, and wherein the first end includes a first eyelet and the second end includes a second eyelet;
a first orthodontic device, wherein the first orthodontic device is configured to be bonded to a first tooth in a patient's mouth, wherein the first orthodontic device includes a first protrusion, and wherein the first protrusion is located within the first eyelet during use in the patient's mouth; and
a second orthodontic device, wherein the second orthodontic device is configured to be bonded to a second tooth in the patient's mouth, wherein the second orthodontic device includes a second protrusion, and wherein the second protrusion is located within the second eyelet during use in the patient's mouth.

2. The orthodontic appliance of claim 1, wherein one or both of the first protrusion and the second protrusion include a limit, wherein the limit limits motion of the main body portion with respect to one or both of the first orthodontic appliance and the second orthodontic appliance.

3. The orthodontic appliance of claim 2, wherein the limit is a portion of the protrusion with a dimension greater than that of one or both of the first eyelet and the second eyelet.

4. The orthodontic appliance of claim 1, wherein the first protrusion has a protrusion base and a protrusion end, wherein a width of the first protrusion at a point between the protrusion base and the protrusion end is less than a width of the first protrusion at the protrusion end.

5. The orthodontic appliance of claim 1, wherein the second protrusion has a protrusion base and a protrusion end, wherein a width of the second protrusion at a point between the protrusion base and the protrusion end is less than a width of the second protrusion at the protrusion end.

6. (canceled)

7. (canceled)

8. The orthodontic appliance of claim 1, wherein one or both of the first eyelet fully encloses the first protrusion during use in the patient's mouth and the second eyelet fully encloses the second protrusion during use in the patient's mouth.

9. (canceled)

10. (canceled)

11. (canceled)

12. (canceled)

13. The orthodontic appliance of claim 1, wherein one or both of the first protrusion and the second protrusion have a rotation-limiting feature, wherein the rotation-limiting feature limits rotation in at least one direction.

14. The orthodontic appliance of claim 13, wherein the rotation-limiting feature limits rotation in a first direction to a first degree and rotation in a second direction to a second degree.

15. (canceled)

16. (canceled)

17. A packaged orthodontic appliance, the packaged orthodontic appliance comprising:
an orthodontic appliance, the orthodontic appliance comprising:
a main body portion, the main body portion including a first end and a second end, wherein the first end is opposite the second end, and wherein the first end includes a first eyelet and the second end includes a second eyelet;
a first orthodontic device, wherein the first orthodontic device is configured to be bonded to a first tooth in a patient's mouth, wherein the first orthodontic device includes a first protrusion, and wherein the first protrusion is located within the first eyelet during use in the patient's mouth; and
a second orthodontic device, wherein the second orthodontic device is configured to be bonded to a second tooth in the patient's mouth, wherein the second orthodontic device includes a second protrusion, and wherein the second protrusion is located within the second eyelet during use in the patient's mouth; and
packaging, wherein the packaging comprises:
a plurality of support structures, wherein the plurality of support structures supports the orthodontic appliance; and
a base, wherein the plurality of support structures secures the orthodontic appliance to the base

18. The packaged orthodontic appliance of claim 17, wherein one or both of the first protrusion and the second protrusion include a limit, wherein the limit limits motion of the main body portion with respect to one or both of the first orthodontic appliance and the second orthodontic appliance.

19. The packaged orthodontic appliance of claim 18, wherein the limit is a portion of the protrusion with a dimension greater than that of one or both of the first eyelet and the second eyelet.

20. The packaged orthodontic appliance of claim 17, wherein the first protrusion has a protrusion base and a protrusion end, wherein a width of the first protrusion at a point between the protrusion base and the protrusion end is less than a width of the first protrusion at the protrusion end.

21. The packaged orthodontic appliance of claim 17, wherein the second protrusion has a protrusion base and a protrusion end, wherein a width of the second protrusion at a point between the protrusion base and the protrusion end is less than a width of the second protrusion at the protrusion end.

22. The packaged orthodontic appliance of claim 17, wherein one or both of the first eyelet fully encloses the first protrusion during use in the patient's mouth and the second eyelet fully encloses the second protrusion during use in the patient's mouth.

23. The packaged orthodontic appliance of claim 17, wherein one or both of the first protrusion and the second protrusion have a rotation-limiting feature, wherein the rotation-limiting feature limits rotation in at least one direction.

24. The packaged orthodontic appliance of claim 23, wherein the rotation-limiting feature limits rotation in a first direction to a first degree and rotation in a second direction to a second degree.

25. A method of manufacturing an orthodontic appliance, the method comprising:
manufacturing the orthodontic appliance, wherein the orthodontic appliance comprises:
a main body portion, the main body portion including a first end and a second end, wherein the first end is opposite the second end, and wherein the first end includes a first eyelet and the second end includes a second eyelet;
a first orthodontic device, wherein the first orthodontic device is configured to be bonded to a first tooth in a patient's mouth, wherein the first orthodontic device includes a first protrusion, and wherein the first protrusion is located within the first eyelet during use in the patient's mouth; and
a second orthodontic device, wherein the second orthodontic device is configured to be bonded to a second tooth in the patient's mouth, wherein the second orthodontic device includes a second protrusion, and wherein the second protrusion is located within the second eyelet during use in the patient's mouth.

26. The method of claim 25, wherein one or both of the first protrusion and the second protrusion include a limit, wherein the limit limits motion of the main body portion with respect to one or both of the first orthodontic appliance and the second orthodontic appliance, and wherein the limit is a portion of the protrusion with a dimension greater than that of one or both of the first eyelet and the second eyelet.

27. The method of claim 25, wherein one or both of the first eyelet fully encloses the first protrusion during use in the patient's mouth and the second eyelet fully encloses the second protrusion during use in the patient's mouth

28. The method of claim 25, wherein one or both of the first protrusion and the second protrusion have a rotation-limiting feature, wherein the rotation-limiting feature limits rotation in at least one direction.
